(19) United States
(12) Patent Application Publication
(10) Pub. No.: US 2019/0389490 A1
(43) Pub. Date: Dec. 26, 2019

(54) Construction of Large Diameter Concrete Pneumatic Tube for Transportation System

(71) Applicant: Craig Hodgetts, Culver City, CA (US)

(72) Inventor: Craig Hodgetts, Culver City, CA (US)

(21) Appl. No.: 16/464,201

(22) PCT Filed: Nov. 24, 2017
(86) PCT No.: PCT/US2017/063200

§ 371 Date: May 24, 2019

Related U.S. Application Data
(60) Provisional application No. 62/497,675, filed on Nov. 28, 2016.

(51) Int. Cl. B61B 13/10; F16L 3/237; F16L 9/08; F16L 23/02

(52) U.S. Cl. CPC B61B 13/10; F16L 3/237; B28B 3/20; F16L 23/02; F16L 9/085

(57) ABSTRACT

The invention includes a tube fabricated for use in a tubeway, which includes a plurality of tube segments. Each tube segment forms a portion of the tube. The tube segment is extruded in a form to allow for joining with other tube segments to form the a tube. Prestressed metallic wires included within each tube segment. The plurality of tube segments are assembled to form the tube. End fittings are provided on each opposing end of the tube segments forming the tube to facilitate joining the tube to other tubes end-to-end. At least one post-tension cable is attached to opposing end fittings on the tube segment. The invention further includes an on-site method for fabricating and assembling the tubeway from the prestressed concrete tube segments.

### RELATED APPLICATIONS

The present application is a nonprovisional conversion of U.S. provisional patent application Ser. No. 62/497,675, filed on Nov. 28, 2016, which is incorporated herein by reference and to which priority is claimed pursuant to 35 USC 119.

### BACKGROUND

### Field of the Technology

The invention relates to a method of construction of a concrete tube used as a partially evacuated transport tube for a long distance, high speed transportation system and the article of manufacture constructed by the method.

### Description of the Prior Art

Hyperloop is a mode of transportation that moves freight and people quickly, safely, on-demand and direct from origin to destination. Passengers or cargo are loaded into the Hyperloop vehicle and accelerate gradually via electric propulsion through a low-pressure tube. The vehicle floats above the track using magnetic levitation and glides at airline speeds for long distances due to ultra-low aerodynamic drag.

Hyperloop One systems will be built on columns or tunneled below ground to avoid dangerous grade crossings and wildlife. It's fully autonomous and enclosed, eliminating pilot error and weather hazards. It's safe and clean, with no direct carbon emissions.

However, the construction of Hyperloop One is being proposed as being made out of metallic or synthetic composite tube segments, which are costly and difficult to manufacture on-site.

### BRIEF SUMMARY

The illustrated embodiments of the invention include a method of fabricating a tube for use in a tubeway including the steps of extruding a plurality of tube segments, each tube segment forming a portion of the tube, the tube segment being extruded in a form to allow for joining with other tube segments to form the tube; including prestressed metallic wires within each tube segment; assembling the plurality of tube segments into the tube; providing end fittings on each opposing end of the tube segments forming the tube to facilitate joining the tube to other tubes end-to-end; and providing at least one post-tension cable attached to opposing end fittings on the tube segment.

The step of extruding a plurality of tube segments forming a portion of the tube is performed on site.

The step of extruding a plurality of tube segments forming a portion of the tube includes extruding the tube segments forming a portion of the tube from concrete.

Each tube segment has a wall and the method further includes extruding at least one longitudinal bore in the wall of each tube segment as an available service conduit.

The step of extruding a plurality of tube segments forming a portion of the tube includes extruding at least three tube segments which form the tube.

The step of extruding a plurality of tube segments forming a portion of the tube includes extruding a plurality of tube segments of a right circular cylindrical tube. Other cross-sectional configurations for the tube are included within the scope of the invention, including, but not limited to elliptical shapes or free form cross sections.

The method further includes the step of defining a predetermined end profile at each opposing end of each of the plurality tube segment to facilitate joining of the tube end-to-end with other tubes.

The step of defining a predetermined end profile at each opposing end of each of the plurality tube segment to facilitate joining of the tube end-to-end with other tubes includes providing an end ring fitting coupled to each opposing end of the tube.

The step of providing an end ring fitting coupled to each opposing end of the tube further includes providing an engaging structure on the end ring fitting to facilitate coupling of the tube to an end ring fitting on an adjacent tube.

The method further includes the step of assembling at least two tubes and coupling the at least two tubes together to provide increased span strength of the two tubes.

The step of assembling at least two tubes and coupling the at least two tubes together to provide increased span strength of the two tubes includes vertically coupling the at least two tubes together.

The method further includes the step of loading the tube onto a wheeled vehicle for transport of the tube to the site of construction of the tubeway.

The method further includes the steps of: providing a plurality of pylons, a plurality of pylon foundations supporting the pylons, and a support structure coupled to each of the pylons for supporting the tube; positioning the wheeled vehicle loaded with a tube with respect to the plurality of pylon foundations supporting the pylons, and support structure; and moving the tube from the wheeled structure to a position to be coupled to other tube or to the support structure to which the moved tube or other tube is directly or indirectly coupled.

The wheeled vehicle is a trailer and the step of moving the tube from the wheeled structure to a position to be coupled to other tube or to the support structure to which the moved tube or other tube is directly or indirectly coupled includes lifting the tube into position using a hydraulic lift.

The scope of the illustrated embodiments of the invention also include a tube fabricated for use in a tubeway. The tube includes: a plurality of tube segments, each tube segment forming a portion of the tube, the tube segment being extruded in a form to allow for joining with other tube segments to form the tube; prestressed metallic wires included within each tube segment; the plurality of tube segments being assembled to form the tube; end fittings provided on each opposing end of the tube segments forming the tube to facilitate joining the tube to other tubes end-to-end; and at least one post-tension cable attached to opposing end fittings on the tube segment.

In the illustrated embodiment each tube segments forms a portion of the tube is fabricated on site.

The extruded tube segments are formed from prestressed, steel reinforced concrete.

The plurality of tube segments forming the tube comprise at least three tube segments.

The tube further includes a predetermined end profile at each opposing end of each of the plurality tube segment to facilitate joining of the tube end-to-end with other tubes and an end ring fitting coupled to each opposing end of the tube with an engaging structure on the end ring fitting to facilitate coupling of the tube to an end ring fitting on an adjacent tube.

The tube may be included in an assembly of at least two tubes and coupled together to provide increased span strength of the two tubes as a tube assembly. The tubes are coupled together vertically to provide increased span strength of the two tubes as a tube assembly.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a diagram of a tubeway under construction.

FIG. 2 is perpendicular cross sectional view of a completed tube comprised of three tube segments.

FIG. 3 is a diagrammatic perspective view of an extrusion bed wherein the tube segments of FIG. 2 forming the tubeway of FIG. 1 are extruded on site.

FIG. 4 is an enlarged is perpendicular cross sectional view of a portion of two tube segments where their longitudinal joints are coupled.

FIG. 5 is a diagrammatic view of two completed tubes which have been assembled to comprise a vertically coupled pair for increase span strength.

FIG. 6 is a diagrammatic perspective view of a wheeled vehicle onto which the completed tube pairs of FIG. 5 are loaded and then lifted up to be connected to support structures on pylons and/or to other prepositioned tubes.

FIG. 7 is a diagrammatic plan side view of a completed portion of an elevated tubeway fabricated according to the illustrated embodiments of FIGS. 1-6.

FIG. 8 is a perspective exploded view of two adjacent tube segments illustrating how the alignment ring and its alignment plugs alignment adjacent tube segments and provide for transfer of stresses between them.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

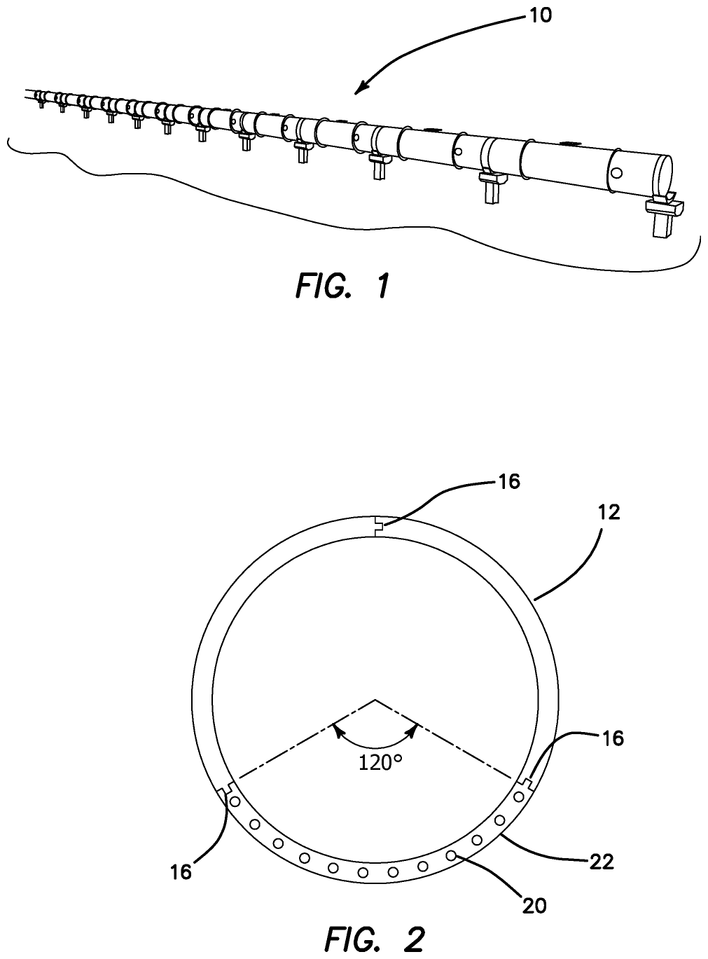

The illustrated embodiments of the invention provide an economically feasible method of construction for a long distance, high speed transportation system, which is comprised of a network or chain 10 of partially evacuated or pneumatic tubes as shown in FIG. 1 within which a pressurized passenger capsule travels at speeds approaching 700 mph using electromagnetic, linear propulsion. The system is a point to point system deployed over many hundreds of miles. One such system is being proposed by the Boring Company under the name, Hyperloop. One requirement is that the hundreds of miles of pneumatic tube within which the passenger capsule travels be constructed in a cost-effective manner.

Among the advantages of the illustrated embodiments disclosed below is that the construction method is adaptable to a “just-in-time” construction process by co-locating the production facilities for the tube along the projected route. Raw materials for the construction are or can be delivered via conventional transport. Because the tube which is fabricated is light weight, the need for costly erection equipment is avoided. The mechanical strength of the tubes made according to the disclosed embodiment lends itself to extremely long spans thus reducing the cost of supporting structures. A rapid erection time with minimum equipment saves time and money. The method uses a proven pre-stressed concrete technology. The fabrication of the tube is performed so that it integrates guideway and structural support with a single element, thus saving cost by eliminating redundancies. The construction process does not generate construction debris and uses a minimum amount of material.

The tube segment 14 as shown in perpendicular cross section in FIG. 2 is comprised of three or more extruded concrete planks or prismatic cylindrical segments 12, each of which is curved to create a complete cylinder of a predetermined diameter or other closed form when assembled. In the illustrated embodiment of FIG. 2 three identical prismatic cylinder segments 12 of about 120° each, when assembled comprise a circular cylindrical tube segment 14. Again in the illustrated embodiment a radius of 12 feet is provided, but the radius, the length and the number of cylindrical segments 12 comprising tube segment 14 is a matter of design choice within the spirit and scope of the invention. The longitudinal edge of each cylindrical segment 12 is molded to include a tongue-and-groove joint 16, ship lap joint or other joint engaging shape with the adjacent cylindrical segment 12. Joint 16 is sealed either by its joining structure or the inclusion of grout, adhesive or a sealant disposed into the joint 16.

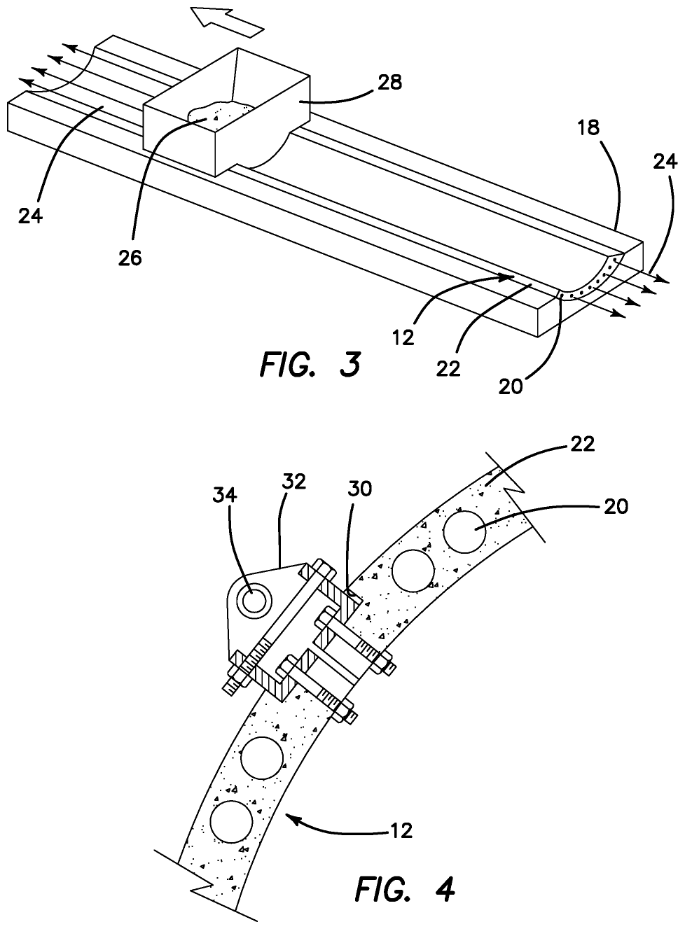

Cylindrical segments 12 are made on-site using an extrusion bed 18 as shown in FIG. 3, which bed 18 is a cylindrical segment with a radius conforming to the desired radius of the tube segment 14. The extruded concrete cylindrical segments 12, individually and collectively, have a coextruded alignable, cylindrical bores 20 extending linearly through the longitudinal length of the wall 22 of segment 12. These bores 20 may be utilized for communications wiring, power, or other needs, which require a colinear path within the tube. Steel prestressing wires 24 are stretched or tensioned over semi-circular bed 18 as shown in FIG. 3 and are defined within the concrete wall 22 of segment 12 as it is extruded in bed 18 in order to form a prestressed concrete “plank” or cylindrical segment 12 when the concrete mix has solidified. As shown in FIG. 3 a concrete hopper 26 is loaded with the wet or unset concrete mix and fed to a moving extrusion device 28, which extrudes cylindrical segment 12 into the top receiving surface of extrusion bed 18 with pretensioning wires 24 fed from upstream from extrusion device 28 into the extruded concrete being extruded from extrusion device 28 with bores 20 being defined therein by extrusion. The details of the extrusion device 28 are conventional for extruded concrete forms and is well known. Such extrusion devices are routinely used to fabricate extruded curbs, sidewalks and landscaping borders on site.

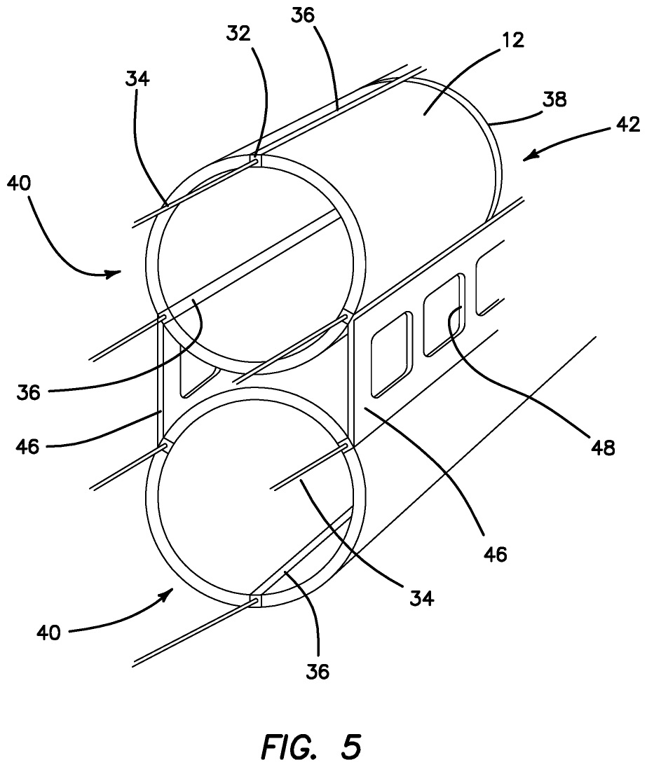

The longitudinal seams or edges 36 of the “plank” or cylindrical segment 12 as best seen in FIG. 5 are formed to create a profile or seating surface 30 suitable for the attachment of a metallic fitting 32 which will serve as a coupling between adjacent cylindrical segments 12 in order to create a continuous cylindrical form. Surface 30 and any other bores or surface modifications to segment 12 may be molded, drilled, cut or formed by any means known, but preferably are formed in the extruded segment 12 while the material is still green or only partially set. Post-tension steel cables or rods 34 are disposed through the metallic fitting 32 to longitudinally couple the cylindrical segments 12 together as best depicted in FIG. 5 to provide increased longitudinal strength to tube segments 14 when assembled and spanning large distances. Fittings 32 may be provided as brackets bolted to the circular ends of each tube segment 14 as shown in cross section in FIG. 4, or may be include prismatic bodies that extend longitudinally along the entire or nearly the entire longitudinal length of each cylindrical segment 12 to assist in radialy binding segments 12 together. In any case, segments 12 are grouted, adhesively sealed, or otherwise sealed by any conventional means along their longitudinal joints 36 to provide an air-tight enclosure within tube segment 14.

A steel or suitably strong ring 38, which is capable of carrying shear stresses generated by the “beam strength” of two adjacent tube segments 14 when used to span a large distance, is circumferentially bolted to or otherwise fixed to and between the opposing ends of the extruded cylindrical tube segments 14. Metallic fittings 32 may be fixed to metallic rings 38 or integrally formed therewith so that post-tension cable 34 forms part of the reinforcing system with rings 38. A cylindrical tube segment 14 with its rings 38 and end fittings 32 comprise a module 40. A steel socket ring 39 as best seen in FIG. 8 is provided on each opposing end of each module 40, which together with alignment ring 42 carrying a plurality of alignment plugs 43, combine to provide positive alignment with the adjacent tube segment 14. Alignment plugs 43 are conical pins which provide transfer of stress between adjacent tube segments 14 when positioned between opposing socket rings 39 on the opposing ends of adjacent tube segments 14. Alignment plugs 43 extend into or through ring 39 and may further extend a mating bore defined into the side wall of tube segment 14. For example, rings 38 may be provided with mating tongue-and-groove coupling end surfaces, a plurality of mating pins and sockets, a plurality of mating tendons and slots or any other conventional means for mechanical coupling and reinforcement with an adjacent ring 38 capping the adjacent end of the adjacent tube segment 14.

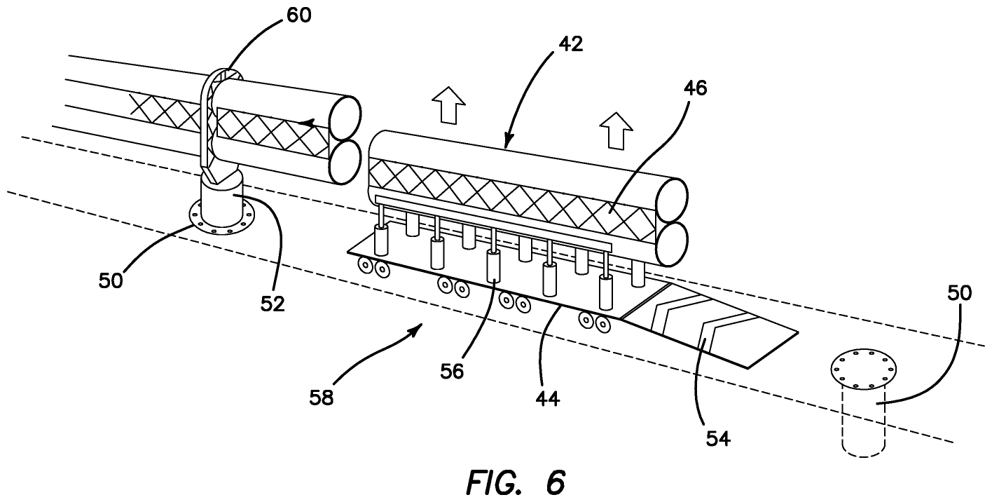

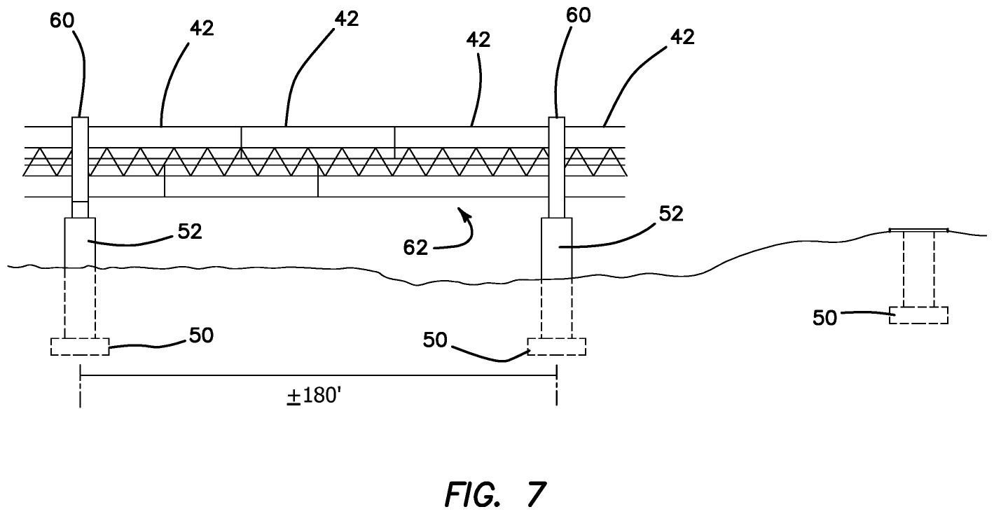

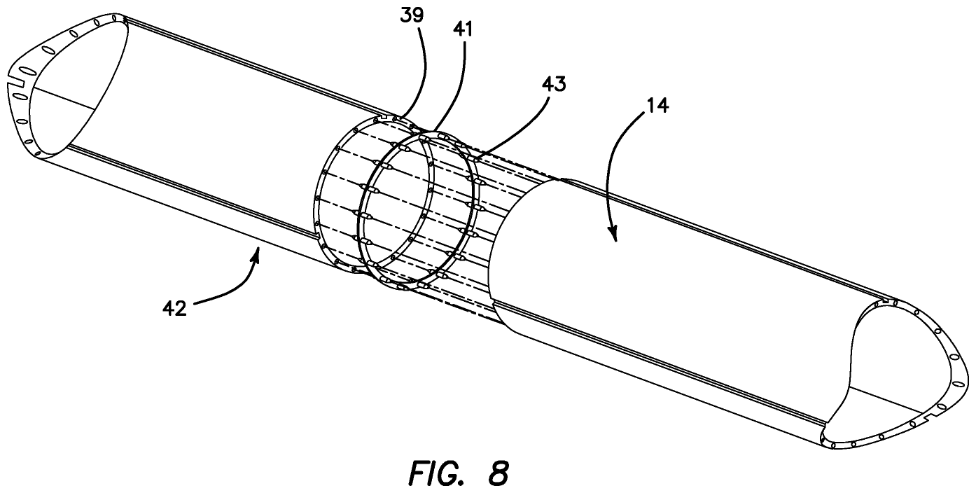

A site assembly process as shown in FIGS. 6 and 7 includes the steps of locating a concrete tube assembly 42 on a wheeled trailer 44 for transport of tube assemblies 42 to the required position along the route of the tube network 10. As best shown in FIG. 5 modules 40 may be assembled in network 10 as single tube pathways as shown in FIG. 1 or in groups of two or more modules 40 forming a tube assembly 42. In the embodiment where two modules 40 are combined into a tube assembly 42, modules 40 are coupled in co-parallel using steel shear connector 46 to provide a two track tubeway 62. Shear connector 46 may take many forms, including but not limited to a metallic shear plate with lightening cutouts 48 as seen in FIG. 5 or a net of cables forming a shear ties shown in FIGS. 6 and 7. Many other construction systems for combining tube segments 14 into tube assemblies 42 may be employed without departing from the spirit and scope of the invention. Pylon foundations 50 for the tube support pylons 52 are located along the selected route. The mobile assembly rig 58 of FIG. 6 is positioned at an appropriate distance from the pylon foundation 50. A loading ramp 54 is positioned at the end of the assembly rig 5. The concrete tube assembly 42 is positioned on the assembly rig 58 using loading ramp 54. A steel tube support structure 60 is erected on top of the pylon 52. Hydraulic erection pistons 56 are attached to the shear tie structure 46 in preparation for erection of tube assembly 42 into structure 60 or to an adjacent erected tube assembly 42 according to the construction configuration presented. What results is then the completed tubeway 62 of FIG. 7.

Below ground or versions fabricated in tunnels will be modified in conventional ways that are well known to accommodate a tubeway 62 underground as opposed the above ground installation shown in FIGS. 6 and 7. The essential on-site fabrication and assembly using prestressed extruded concrete as disclosed above does not materially change as a result.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A method of fabricating a tube for use in a tubeway comprising:
extruding a plurality of tube segments, each tube segment forming a portion of the tube, the tube segment being extruded in a form to allow for joining with other tube segments to form the tube;
including prestressed metallic wires within each tube segment;
assembling the plurality of tube segments into the tube;
providing end fittings on each opposing end of the tube segments forming the tube to facilitate joining the tube to other tubes end-to-end; and
providing at least one post-tension cable attached to opposing end fittings on the tube segment.

2. The method of claim 1 where extruding a plurality of tube segments forming a portion of the tube is performed on site.

3. The method of claim 1 where extruding a plurality of tube segments forming a portion of the tube comprises extruding the tube segments forming a portion of the tube from concrete.

4. The method of claim 1 where each tube segment has a wall and further comprising extruding at least one longitudinal bore in the wall of each tube segment as an available service conduit.

5. The method of claim 1 where extruding a plurality of tube segments forming a portion of the tube comprises extruding at least three tube segments which form the tube.

6. The method of claim 1 where extruding a plurality of tube segments forming a portion of the tube comprises extruding a plurality of tube segments of a right circular cylindrical tube.

7. The method of claim 1 further comprising defining a predetermined end profile at each opposing end of each of the plurality tube segment to facilitate joining of the tube end-to-end with other tubes.

8. The method of claim 7 where defining a predetermined end profile at each opposing end of each of the plurality tube segment to facilitate joining of the tube end-to-end with other tubes comprises providing an end ring fitting coupled to each opposing end of the tube.

9. The method of claim 8 where providing an end ring fitting coupled to each opposing end of the tube further comprises providing an engaging structure on the end ring fitting to facilitate coupling of the tube to an end ring fitting on an adjacent tube.

10. The method of claim 1 further comprising assembling at least two tubes and coupling the at least two tubes together to provide increased span strength of the two tubes.

11. The method of claim 10 where assembling at least two tubes and coupling the at least two tubes together to provide increased span strength of the two tubes comprises vertically coupling the at least two tubes together.

12. The method of claim 1 further comprising loading the tube onto a wheeled vehicle for transport of the tube to the site of construction of the tubeway.

13. The method of claim 12 further comprising:
providing a plurality of pylons, a plurality of pylon foundations supporting the pylons, and a support structure coupled to each of the pylons for supporting the tube;
positioning the wheeled vehicle loaded with a tube with respect to the plurality of pylon foundations supporting the pylons, and support structure; and
moving the tube from the wheeled structure to a position to be coupled to other tube or to the support structure to which the moved tube or other tube is directly or indirectly coupled.

14. The method of claim 13 where the wheeled vehicle is a trailer and where moving the tube from the wheeled structure to a position to be coupled to other tube or to the support structure to which the moved tube or other tube is directly or indirectly coupled comprises lifting the tube into position using an hydraulic lift.

15. A tube fabricated for use in a tubeway comprising:
a plurality of tube segments, each tube segment forming a portion of the tube, the tube segment being extruded in a form to allow for joining with other tube segments to form the tube;
prestressed metallic wires included within each tube segment;
the plurality of tube segments being assembled to form the tube;
end fittings provided on each opposing end of the tube segments forming the tube to facilitate joining the tube to other tubes end-to-end; and
at least one post-tension cable attached to opposing end fittings on the tube segment.

16. The tube of claim 15 where each tube segments forming a portion of the tube is fabricated on site.

17. The tube of claim 15 where the extruded tube segments are formed from prestressed, steel reinforced concrete.

18. The tube of claim 15 where the plurality of tube segments forming the tube comprise at least three tube segments.

19. The tube of claim 15 further comprising a predetermined end profile at each opposing end of each of the plurality tube segment to facilitate joining of the tube end-to-end with other tubes and an end ring fitting coupled to each opposing end of the tube with an engaging structure on the end ring fitting to facilitate coupling of the tube to an end ring fitting on an adjacent tube.

20. The tube of claim 15 further comprising an assembly of at least two tubes coupled together to provide increased span strength of the two tubes as a tube assembly.

21. The tube of claim 20 where the at least two tubes are coupled together vertically to provide increased span strength of the two tubes as a tube assembly.
